(19) United States
(12) Patent Application Publication
(10) Pub. No.: US 2023/0395808 A1
(43) Pub. Date: Dec. 7, 2023

(54) NONAQUEOUS ELECTROLYTE RECHARGEABLE BATTERY AND METHOD FOR MANUFACTURING POSITIVE ELECTRODE PLATE OF NONAQUEOUS ELECTROLYTE RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Shotaro DEGUCHI, Toyohashi-shi (JP); Kazutaka YOSHIKAWA, Hamamatsu-shi (JP)

(73) Assignees: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(21) Appl. No.: 18/204,325

(22) Filed: May 31, 2023

(30) Foreign Application Priority Data
Jun. 3, 2022 (JP) 2022-091172

(51) Int. Cl. H01M 4/66; H01M 4/62; H01M 4/04; H01M 4/139

(52) U.S. Cl. CPC H01M 4/667; H01M 4/625; H01M 4/664; H01M 2004/021; H01M 4/139; H01M 4/0435; H01M 4/0404

(57) ABSTRACT

A nonaqueous electrolyte rechargeable battery includes a positive electrode plate, a negative electrode plate, a separator, and a nonaqueous electrolyte. The positive electrode plate includes a positive electrode current collector, a positive electrode mixture layer including positive electrode active material particles and a conductor, and an insulative protection layer including insulative particles and a binder. In the insulative protection layer, a value of (the insulative particles)/(the insulative particles+the binder) is between 75 wt % and 85 wt %, inclusive. A single-surface thickness T_{I} of the insulative protection layer is between 3.0 μm and 15 μm, inclusive. A porosity P_{I} of the insulative protection layer is between 42% and 55%, inclusive. A ratio of the single-surface thickness T_{I} to a single-surface thickness T_{P} of the positive electrode mixture layer is between 0.12 and 0.80, inclusive.

### BACKGROUND

### 1. Field

The following description relates to a nonaqueous electrolyte rechargeable battery and a method for manufacturing a positive electrode plate of a nonaqueous electrolyte rechargeable battery, and more particularly, a nonaqueous electrolyte rechargeable battery and a method for manufacturing a positive electrode plate of a nonaqueous electrolyte rechargeable battery that avoid high-rate deterioration.

### 2. Description of Related Art

A nonaqueous electrolyte rechargeable battery, such as a lithium-ion rechargeable battery, is light in weight and high in energy density, and thereby used as a preferred high-output power source that is installed in a vehicle. Such a nonaqueous electrolyte rechargeable battery includes a rolled electrode body in which an electricity storage element, formed by a stack of a positive electrode and a negative electrode insulated from each other by a separator or the like, is rolled into a columnar shape or an elliptical columnar shape in a battery case. Typically, the positive electrode and the negative electrode of the electrode body are designed such that a negative electrode mixture layer is wider than a positive electrode mixture layer. Thus, the negative electrode mixture layer opposes a positive electrode current collector, from which metal is exposed, with the separator located in between. Short circuiting will not occur under a normal situation because of the separator. However, when metal is deposited on the negative electrode or fine metal powder or the like enters the negative electrode, short circuiting may occur through the separator and generate heat.

In order to avoid such short circuiting, for example, Japanese Laid-Open Patent Publication No. 2017-157471 discloses the following invention. Specifically, a positive electrode includes a positive electrode current collector foil, an insulative protection layer including an insulative material, and a positive electrode mixture layer including a positive electrode active material. The positive electrode mixture layer and the insulative protection layer are formed on at least one surface of the positive electrode current collector foil of a positive electrode plate.

Such an insulative protection layer covers a metal plate forming the positive electrode current collector with an insulator so that occurrence of short circuiting in a negative electrode mixture layer through the separator is avoided effectively even when metal Li is deposited on the negative electrode mixture layer or when foreign matter such as fine metal powder enters the negative electrode mixture layer.

Further, Japanese Laid-Open Patent Publication No. 2017-157471 discloses a structure in which an overlapped portion of the insulative protection layer is covered with an overlapping portion of the positive electrode mixture layer. This avoids delamination of the insulative protection layer from the positive electrode current collector foil.

In a nonaqueous electrolyte rechargeable battery, an electrolyte moves when charging and discharging are performed at a high rate. In this case, if the insulative protection layer causes insufficient movement of the nonaqueous electrolyte within the battery cell, the concentration of the nonaqueous electrolyte becomes uneven. This may result in deterioration of the battery, or “high-rate deterioration”. However, such a problem is not recognized by the invention described in Japanese Laid-Open Patent Publication No. 2017-157471.

Further, although the invention described in Japanese Laid-Open Patent Publication No. 2017-157471 avoids delamination of the insulative protection layer from the positive electrode current collector foil at the portion where the insulative protection layer overlaps the positive electrode mixture layer, the invention does not disclose a structure that avoids delamination of the entire insulative protection layer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a nonaqueous electrolyte rechargeable battery includes a positive electrode plate, a negative electrode plate, a separator insulating the positive electrode plate and the negative electrode plate, and a nonaqueous electrolyte. The positive electrode plate includes a positive electrode current collector, a positive electrode mixture layer arranged on a part of at least one surface of the positive electrode current collector and including positive electrode active material particles and a conductor, and an insulative protection layer arranged on another part of the at least one surface of the positive electrode current collector adjacent to the positive electrode mixture layer and including insulative particles and a binder. In the insulative protection layer, a value of (the insulative particles)/(the insulative particles+the binder) is between 75 wt % and 85 wt %, inclusive. A single-surface thickness T_{I} of the insulative protection layer is between 3.01 μm and 151 μm, inclusive. A porosity P_{I} of the insulative protection layer is between 42% and 55%, inclusive. A ratio of the single-surface thickness T_{I} of the insulative protection layer to a single-surface thickness T_{P} of the positive electrode mixture layer is between 0.12 and 0.80, inclusive. The ratio of the single-surface thickness T_{I} of the insulative protection layer to the single-surface thickness T_{P} of the positive electrode mixture layer may be between 0.12 and 0.60, inclusive. A density D_{P} of the positive electrode mixture layer may be between 2.2 g/cm³ and 3.0 g/cm³, inclusive. A porosity P_{P} of the positive electrode mixture layer may be between 30% and 50%, inclusive.

The conductor of the positive electrode mixture layer may be a conductive material having an aspect ratio of thirty or greater. The conductor may be formed by carbon nanotubes or carbon nanofibers.

The insulative protection layer may have a density D_{I} of between 1.2 g/cm³ and 1.6 g/cm³, inclusive and a delamination strength of 10 N or greater.

The positive electrode mixture layer may overlap the insulative protection layer at a boundary portion where the positive electrode mixture layer is adjacent to the insulative protection layer.

The insulative particles may be formed from boehmite or alumina.

In another general aspect, in a method for manufacturing a positive electrode plate of a nonaqueous electrolyte rechargeable battery, the nonaqueous electrolyte rechargeable battery includes a positive electrode plate, a negative electrode plate, a separator insulating the positive electrode plate and the negative electrode plate, and a nonaqueous electrolyte. The positive electrode plate includes a positive electrode current collector, a positive electrode mixture layer arranged on a part of at least one surface of the positive electrode current collector and including positive electrode active material particles and a conductor, and an insulative protection layer arranged on another part of the at least one surface of the positive electrode current collector adjacent to the positive electrode mixture layer and including insulative particles and a binder. The method includes simultaneously applying an insulative protection paste including insulative particles, a binder, and a solvent, and a positive electrode mixture paste including positive electrode active material particles, a conductor, a binder, and a solvent on a surface of the positive electrode current collector to form the positive electrode mixture layer, the insulative protection layer arranged adjacent to the positive electrode mixture layer, and a boundary portion where the positive electrode mixture layer overlaps the insulative protection layer. The method further includes pressing the positive electrode mixture layer, and simultaneously pressing the insulative protection layer and the boundary portion.

At the boundary portion, the insulative protection layer may be formed on the positive electrode current collector, and the positive electrode mixture layer may be formed overlapping the insulative protection layer.

Further, the pressing the insulative protection layer and the boundary portion may be roller pressing and use a stepped roll that is stepped to have different radii in order to press the insulative protection layer and the boundary portion without pressing the positive electrode mixture layer.

The pressing the insulative protection layer and the boundary portion may include applying tension to the positive electrode current collector so that the insulative protection layer and the boundary portion are forced against the stepped roll.

Other features and aspects will be apparent from the following detailed description, the drawings, and the claims.

### BRIEF DESCRIPTION OF THE DRAWINGS

FIG. 1 is a perspective view schematically showing the structure of a lithium-ion rechargeable battery in accordance with the present embodiment.

FIG. 2 is a diagram schematically showing the structure of a roll of an electrode body in accordance with the present embodiment.

FIG. 3 is a schematic cross-sectional view showing the structure of a stack forming the electrode body of the lithium-ion rechargeable battery.

FIG. 4 is an enlarged diagram of a portion A shown in FIG. 3, schematically showing a boundary portion B between a positive electrode mixture layer and an insulative protection layer in an applying step of the present embodiment.

FIG. 5 is a flowchart illustrating a method for manufacturing a positive electrode plate of the present embodiment.

FIG. 6 is a perspective view illustrating the applying step.

FIG. 7 is a perspective view schematically showing a first nozzle and a second nozzle of a coater including the cross section of the coater taken along VII-VII portion.

FIG. 8 is a diagram schematically showing an electrode body 12 after the applying step (S3) is completed.

FIG. 9 is a diagram schematically illustrating a positive electrode mixture layer pressing step (S5).

FIG. 10 is a perspective view schematically illustrating a boundary portion and insulative protection layer pressing step (S6).

FIG. 11 is a cross-sectional view schematically illustrating when the boundary portion and insulative protection layer pressing step (S6) is initiated.

FIG. 12 is a cross-sectional view schematically showing the operation of the boundary portion and insulative protection layer pressing step (S6).

FIG. 13 is a table showing results of experimental examples.

FIG. 14 is a diagram schematically showing the electrode body of the present embodiment.

FIG. 15 is a diagram schematically showing an electrode body known in the art.

FIG. 16 is a diagram schematically showing a state in which short circuiting is caused by foreign matter in the insulative protection layer having an excessively high porosity P_{I}.

FIG. 17 is a diagram schematically showing the insulative protection layer having a low porosity P_{I} in accordance with the present embodiment.

FIG. 18 is a diagram schematically showing the insulative protection layer being separated because porosity P_{I} is excessively high or thickness T_{I} is too small.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Present Embodiment

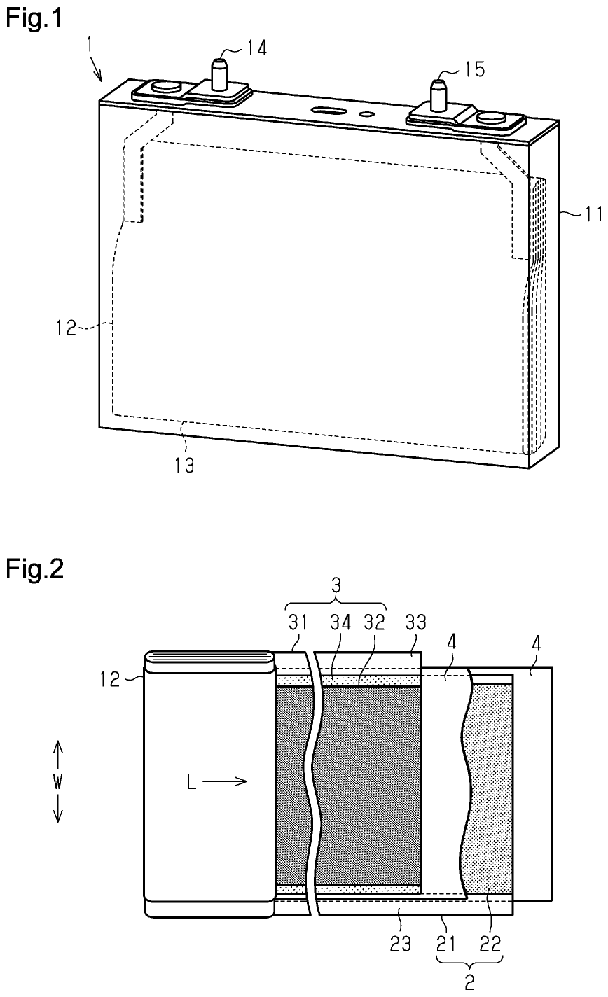

A nonaqueous electrolyte rechargeable battery and a method for manufacturing a positive electrode plate in accordance with the present disclosure will now be described with an embodiment of a lithium-ion rechargeable battery 1 and a method for manufacturing an electrode plate of the lithium-ion rechargeable battery 1 with reference to FIGS. 1 to 18.

### Problems of Prior Art

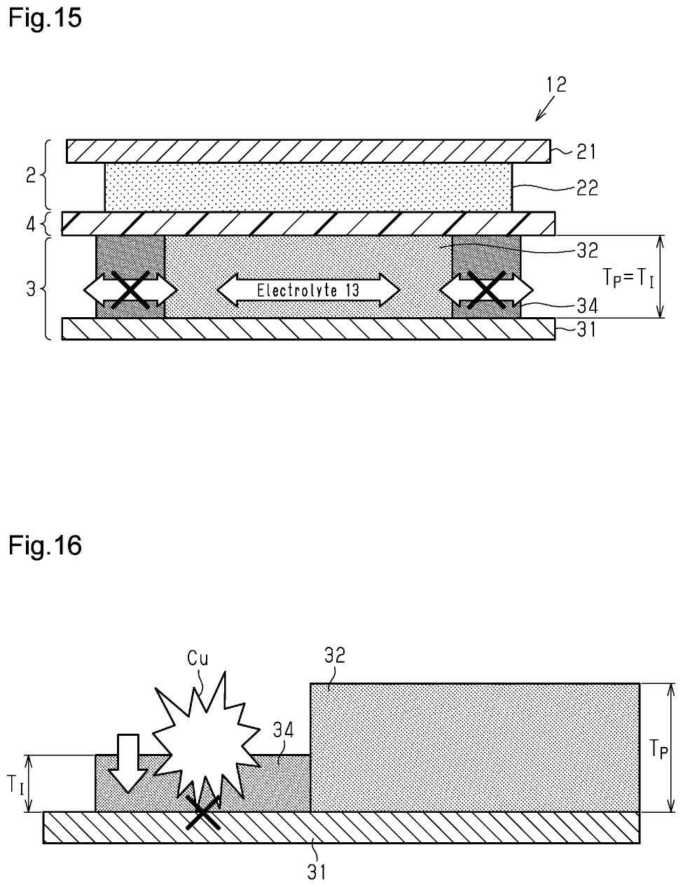

FIG. 15 is a diagram schematically showing an electrode body 12 known in the art. As described in the related art section and as shown in FIG. 15, an insulative protection layer 34 is arranged adjacent to the two ends of a positive electrode mixture layer 32 so that occurrence of a micro-short-circuit is avoided.

However, in the lithium-ion rechargeable battery 1, an electrolyte moves when charging and discharging are performed at a high rate. As shown in FIG. 15, in the conventional structure, thickness T_{I} of the insulative protection layer 34 is equal to thickness T_{P} of the positive electrode mixture layer 32. In such a structure, the insulative protection layer 34 hinders the movement of the electrolyte within the battery cell and thus the concentration of the electrolyte becomes uneven. This may cause the problem of deterioration of the battery, or “high-rate deterioration”.

FIG. 14 is a diagram schematically showing an electrode body 12 of the present embodiment. In an electrode body 12 of the lithium-ion rechargeable battery 1 in accordance with the present embodiment, thickness T_{I} of the insulative protection layer 34 is set to less than thickness T_{P} of the positive electrode mixture layer 32 so that a nonaqueous electrolyte 13 moves easily.

Porosity P (%)

Porosity P (%) is a scale indicating the volume of pores such as voids between particles. Porosity P (%) is generally proportional to a coefficient of water permeability. Thus, in the present embodiment, porosity P (%) is used as an index of the efficiency at which the electrolyte 13 flows through the positive electrode mixture layer 32 in a cell.

Further, porosity P (%) also serves an index of the distances between positive electrode active material particles 32b in the positive electrode mixture layer 32.

Porosity P (%) is measured by, for example, a liquid immersion method in which a porous sample is immersed in a liquid having a high wettability to saturate the pores with the liquid. Porosity P (%) may be measured using an optical method in which microscopic observation is conducted on a cross section of a sample to determine an area of the material and an area of the visible voids. Further, porosity P (%) may be measured by, for example, mercury porosimetry in which an amount of mercury, having a high surface tension, injected into fine pores of a sample is measured with respect to the externally applied pressure so as to obtain the distribution and volume of the pores.

Change in Porosity P (%) in Pressing Step

In the positive electrode mixture layer 32, when porosity P (%) is lowered in the pressing step, the distances between the positive electrode active material particles 32b in the positive electrode mixture layer 32 decrease so that the conductive path and the battery performance are improved.

However, in the invention described in the above patent publication, the insulative protection layer 34 is also compressed in the pressing step and thus the distances between insulative particles 34b in the insulative protection layer 34 decrease. This lowers porosity P (%) of the insulative protection layer 34. When porosity P (%) of the insulative protection layer 34 is lowered, the electrolyte 13 is exchanged with low efficiency in the positive electrode mixture layer 32. Accordingly, the concentration of the electrolyte 13 in the battery becomes uneven, particularly when charging and discharging of the battery is performed at a high rate. This increases the tendency of deterioration of the battery, or “high-rate deterioration” to occur.

FIG. 16 shows a case in which thickness T_{I} of the insulative protection layer 34 is less than thickness T_{P} of the positive electrode mixture layer 32, and porosity P_{I} of the insulative protection layer 34 is excessively high. FIG. 16 is a diagram schematically showing a state in which the strength of the insulative protection layer 34 is decreased due to the high porosity P_{I} and thus short circuiting is caused by foreign matter. A greater porosity P_{I} facilitates the movement of the electrolyte. However, if porosity P_{I} becomes too high, for example, acutely shaped metal such as copper (Cu) or the like may enter the insulative protection layer 34, and foreign matter may penetrate the insulative protection layer 34 and cause short circuiting.

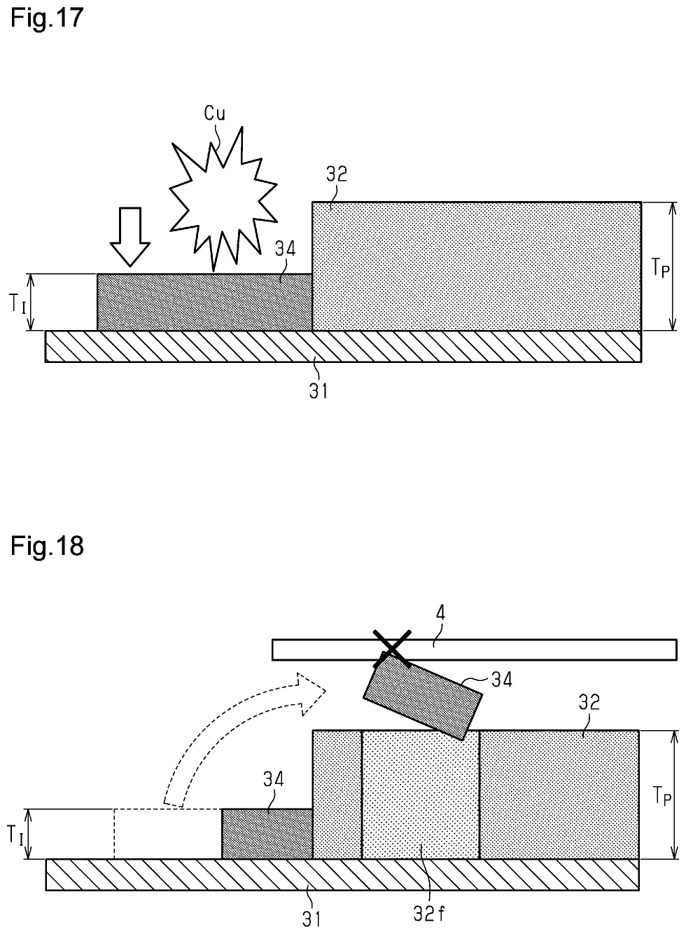

FIG. 17 is a diagram schematically showing the insulative protection layer 34 having a low porosity P_{I} in accordance with the present embodiment. In the present embodiment, the strength of the insulative protection layer 34 is increased so that porosity P_{I} is not excessively high. The insulative protection layer 34 having the increased strength maintains the insulation even when acutely shaped metal such as copper (Cu) or the like enters the insulative protection layer 34.

Further, thickness T_{I} of the insulative protection layer 34 is decreased as described above and the lower limit of porosity P_{I} is set so that the nonaqueous electrolyte 13 moves easily under such a condition. However, even when the mechanical strength of the insulative protection layer 34 is increased to maintain the insulation property, the insulative protection layer 34 may be delaminated.

FIG. 18 is a diagram schematically showing the insulative protection layer 34 being separated because porosity P_{I} is excessively high, thickness T_{I} of the insulative protection layer 34 is too small, or the like. There is a problem that even when the above condition is satisfied, if the insulative protection layer 34 is delaminated from the positive electrode current collector 31, the delaminated portion of the insulative protection layer 34 acts as foreign matter. Accordingly, in the present embodiment, the condition is set to solve such problem of delamination of the insulative protection layer 34.

The present inventors have analyzed a structure that solves the above described problems together by changing conditions in various manners through a number of experiments.

Specific Conditions in Present Embodiment

The present inventors have found through experiments that the following numerical ranges are appropriate values to address the above problems.

(single-surface thickness T_{I} of insulative protection layer 34)/(single-surface thickness T_{P} of positive electrode mixture layer 32)

In the insulative protection layer 34 of the present embodiment, thickness T_{I} of the insulative protection layer 34 at one side is set to 15 μm or less in order to avoid “high-rate degradation”. Further, the value of D_{I}/D_{P} is set to 0.12 to 0.80 so that the voids are ensured to allow the movement of the nonaqueous electrolyte 13. More preferably, the ratio of density D_{I} of the insulative protection layer 34 to density D_{P} of the positive electrode mixture layer 32 is set to 0.1 to 0.6.

Porosity P_{I} of Insulative Protection Layer 34

Porosity P_{I} is set to 55% or less so as to ensure the mechanical strength and, in turn, maintain the insulation property of the insulative protection layer 34.

Further, porosity P_{I} is set to 42% or greater so as to allow the movement of the electrolyte and avoid “high-rate deterioration”.

Density D_{I} of Insulative Protection Layer 34

When single-surface thickness T_{I} of the insulative protection layer 34 is decreased, the insulative protection layer 34 becomes less resistant to foreign matter. Accordingly, density D_{I} of the insulative protection layer 34 is set to 1.2 g/cm³ or greater.

Further, density D_{I} of the insulative protection layer 34 is set to 1.6 g/cm³ or less so as to facilitate the movement of the electrolyte.

Single-Surface Thickness T_{I} of Insulative Protection Layer 34

Single-surface thickness T_{I} of the insulative protection layer 34 is set to 3.0 μm or greater so as to ensure the strength of the insulative protection layer 34 and, in turn, maintain the insulation property of the insulative protection layer 34

Composition of Insulative Protection Layer 34

In the composition of the insulative protection layer 34, the value of (insulative particles 34b)/(insulative particles 34b+binder 34c) on a weight basis is set to 85% or less so that the insulative protection layer 34 is less likely to delaminate from the positive electrode current collector 31. The sufficient amount of a binder 34c avoids delamination of the insulative protection layer 34 from the positive electrode current collector 31.

Further, the value of (insulative particles 34b)/(insulative particles 34b+binder 34c) is set to 75% or greater so as to maintain the insulation property. The insulative particles 34b obtaining a high hardness prevent entry of metallic foreign matter, thereby securing an adequate insulation property.

Delamination Strength

Even when the strength of the insulative protection layer 34 is improved by decreasing porosity P_{I} and increasing density D_{I}, if the insulative protection layer 34 is delaminated, the insulative protection layer 34 may act as foreign matter. Thus, it is further preferred that the delamination strength be 10 N or greater. The delamination strength is improved by, for example, selecting an appropriate binder 34c and setting the value of (insulative particles 34b)/(insulative particles 34b+binder 34c) to 85% or less.

Density D_{P} of Positive Electrode Mixture Layer 32

Density D_{P} (g/cm³) of the positive electrode mixture layer 32 is set to 2.2 g/cm³ or greater so that the density of the positive electrode active material particles 32b is increased and the battery performance is improved.

Further, density D_{P} (g/cm³) of the positive electrode mixture layer 32 is set to 3.0 g/cm³ or less so that the electrolyte moves easily.

Porosity P_{P} of Positive Electrode Mixture Layer 32

Porosity P_{P} of the positive electrode mixture layer 32 is set to 50% or less so that the density of the positive electrode active material particles 32b is increased and the battery performance is improved.

Porosity P_{P} of the positive electrode mixture layer 32 is set to 30% or greater so that the electrolyte moves easily.

Aspect Ratio

Preferably, the conductor 32c has an aspect ratio of thirty or greater so that porosity P_{P} of the positive electrode mixture layer 32 is improved. The term “aspect ratio” refers to a ratio of the length to the diameter of a fiber. When the aspect ratio is thirty or greater, even a small mass of the conductor 32c can form an effective conductive network. Thus, the amount of the conductor 32c added to the positive electrode mixture layer 32 can be decreased, thereby increasing porosity P_{P}. The conductor 32c having such characteristics may include, for example, carbon nanotubes (CNT) or carbon nanofibers (CNF).

Structure of Present Embodiment

Structure of Lithium-Ion Rechargeable Battery 1

FIG. 1 is a perspective view schematically showing the structure of the lithium-ion rechargeable battery 1 in accordance with the present embodiment. The structure of the lithium-ion rechargeable battery 1 of the present embodiment will now be described.

As shown in FIG. 1, the lithium-ion rechargeable battery 1 is structured as a battery cell. The lithium-ion rechargeable battery 1 includes a box-shaped battery case 11 having an opening in the upper side. The battery case 11 accommodates the electrode body 12. The battery case 11 is filled with the nonaqueous electrolyte 13 injected through a liquid injection hole. The battery case 11 is formed from metal, such as an aluminum alloy, and forms a sealed battery container. Further, the lithium-ion rechargeable battery 1 includes a positive electrode external terminal 14 and a negative electrode external terminal 15 used for charging and discharging of the lithium-ion rechargeable battery 1. The shapes of the positive electrode external terminal 14 and the negative electrode external terminal 15 are not limited to that shown in FIG. 1.

Electrode Body 12

FIG. 2 is a diagram schematically showing the structure of a roll of the electrode body 12. The electrode body 12 is formed by a flat roll of negative electrode plates 2 and positive electrode plates 3 with separators 4 held in between. In each negative electrode plate 2, a negative electrode mixture layer 22 is formed on a negative electrode current collector 21 that serves as a substrate. The negative electrode plate 2 includes a negative electrode connection portion 23 where the negative electrode mixture layer 22 is not formed and the negative electrode current collector 21 is exposed at one end of the electrode body 12 in a width direction W (rolling axis direction) that is orthogonal to a direction in which the negative electrode current collector 21 is rolled (rolling direction L).

In each positive electrode plate 3, the positive electrode mixture layer 32 is formed on the positive electrode current collector 31 that serves as a substrate. As shown in FIG. 2, the positive electrode plate 3 includes a positive electrode connection portion 33 at the other end of the electrode body 12 (opposite to negative electrode connection portion 23) in the width direction W (rolling axis direction) that is orthogonal to the direction in which the positive electrode current collector 31 is rolled (rolling direction L). The positive electrode connection portion 33 is where the positive electrode mixture layer 32 is not formed and the metal of the positive electrode current collector 31 is exposed.

In the present embodiment, the insulative protection layer 34 is arranged adjacent to the end of the positive electrode mixture layer 32 and opposes the negative electrode mixture layer 22. The insulative protection layer 34 is arranged to cover the exposed positive electrode current collector 31.

Stack Structure of Electrode Body 12

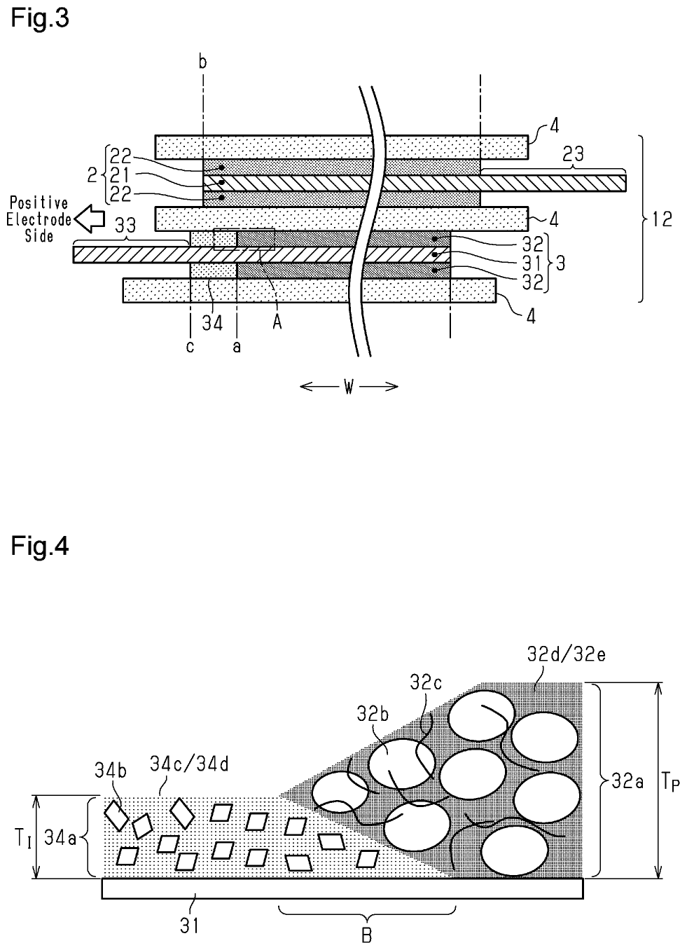

FIG. 3 is a schematic cross-sectional view showing the structure of a stack forming the electrode body 12 of the lithium-ion rechargeable battery 1. As shown in FIG. 2, the basic structure of the electrode body 12 of the lithium-ion rechargeable battery 1 includes a negative electrode plate 2, a positive electrode plate 3, and a separator 4.

The negative electrode plate 2 includes the negative electrode mixture layer 22 on both surfaces of the negative electrode current collector 21, which serves as the negative electrode substrate. An end portion of the negative electrode current collector 21 located at one side of the electrode body 12 defines the negative electrode connection portion 23 where metal is exposed.

The positive electrode plate 3 includes the positive electrode mixture layer 32 on both surfaces of the positive electrode current collector 31, which serves as the positive electrode substrate. An end portion of the positive electrode current collector 31 located at the other side of the electrode body 12 defines the positive electrode connection portion 33 where the metal is exposed.

The negative electrode plate 2 and the positive electrode plate 3 are stacked with the separator 4 held in between. The stack is rolled in its longitudinal direction about the rolling axis to form the flat roll of the electrode body 12.

Further, in the present embodiment, the insulative protection layer 34 is arranged on the positive electrode current collector 31 adjacent to the end of the positive electrode mixture layer 32 that is located toward the positive electrode connection portion 33. If there was no insulative protection layer 34 as in the prior art, the positive electrode current collector 31 would be exposed between an end “a” of the positive electrode mixture layer 32 at the side of the positive electrode connection portion 33 and the edge of the positive electrode. In this case, the positive electrode current collector 31 opposes the negative electrode mixture layer 22 via the separator 4 between the end “a” and an end “b” of the negative electrode mixture layer 22 located at the side of the positive electrode. In such a state, fine metal powder may enter the above region. Further, dendrites of metal Li may grow in the negative electrode mixture layer 22. If such matter penetrates the separator 4, short-circuiting may occur between the negative electrode mixture layer 22 and the positive electrode current collector 31, and generate heat or cause self-discharge. Accordingly, in the present embodiment, the insulative protection layer 34 is arranged from the end “a” to an end “c” beyond the end “b”. Such an insulative protection layer 34 avoids occurrence of short circuiting.

Nonaqueous Electrolyte 13

As shown in FIG. 1, the battery container formed by the battery case 11 is filled with the nonaqueous electrolyte 13. The nonaqueous electrolyte 13 of the lithium-ion rechargeable battery 1 is a composition in which a lithium salt is dissolved in an organic solvent. The lithium salt may include LiClO₄, LiPF₆, LiAsF₆, LiBF₄, LiSO₃CF₃, or the like. Examples of the organic solvent include a cyclic carbonate such as ethylene carbonate, propylene carbonate, butylene carbonate, and trifluoropropylene carbonate; a chain carbonate such as diethyl carbonate, dimethyl carbonate, ethyl methyl carbonate, and dipropyl carbonate; an ether compound such as tetrahydrofuran, 2-methyltetrahydrofuran, and dimethoxyethane; a sulfur compound such as ethyl methyl sulfone and butane sultone; and a phosphorus compound such as triethyl phosphate and trioctyl phosphate. The nonaqueous electrolyte may include one selected from the above or a mixture of two or more selected from the above. The nonaqueous electrolyte 13 is not limited to such a composition.

Components of Electrode Body 12

The components of the electrode body 12, namely, the negative electrode plate 2, the positive electrode plate 3, and the separator 4, will now be described.

In the present embodiment, “average diameter” means a median diameter (D50: 50% volume average particle diameter) that corresponds to 50% accumulation in a volume-based particle size distribution, unless specified otherwise. In the range where the average particle diameter is approximately 1 μm or greater, the average diameter can be obtained by a laser diffraction and light scattering method. In the range where the average particle diameter is approximately 1 μm or less, the average particle diameter can be obtained by a dynamic light scattering (DLS) method. The average particle diameter obtained by the DLS method may be measured in accordance with JISZ8828:2013.

Negative Electrode Plate 2

The negative electrode plate 2 has a structure in which the negative electrode mixture layer 22 is formed on both surfaces of the negative electrode current collector 21, which serves as the negative electrode substrate. The negative electrode current collector 21 is formed by a Cu foil in the embodiment. The negative electrode current collector 21 acts as the body and the base of the negative electrode mixture layer 22. Further, the negative electrode current collector 21 functions as a current collecting member that collects electricity from the negative electrode mixture layer 22. In the present embodiment, a negative electrode active material includes a material that is capable of storing and releasing lithium ions, namely, powders of a carbon material such as graphite or the like.

The negative electrode plate 2 is prepared by, for example, kneading the negative electrode active material, a solvent, and a binder, applying the kneaded negative electrode mixture paste to the negative electrode current collector 21, and then drying the paste.

Positive Electrode Plate 3

The positive electrode plate 3 includes the positive electrode current collector 31, the positive electrode mixture layer 32 applied to the positive electrode current collector 31, and the insulative protection layer 34.

Positive Electrode Current Collector 31

The positive electrode plate 3 has a structure in which the positive electrode mixture layer 32 is formed on both surfaces of the positive electrode current collector 31, which serves as the positive electrode substrate. The positive electrode current collector 31 is formed by an Al foil in the embodiment. The positive electrode current collector 31 acts as the body and the base and a frame of the positive electrode mixture layer 32. Further, the positive electrode current collector 31 functions as a current collecting member that collects electricity from the positive electrode mixture layer 32.

An Al foil is described above as an example of the positive electrode substrate that forms the positive electrode current collector 31. The positive electrode substrate is formed from, for example, a conductive material including a metal having satisfactory electric conduction. The conductive material may include, for example, a material including aluminum or an aluminum alloy. The structure of the positive electrode current collector 31 is not limited to the above description.

Positive Electrode Mixture Layer 32

FIG. 4 is an enlarged diagram of a portion A shown in FIG. 3, schematically showing a boundary portion B where the positive electrode mixture layer 32 overlaps the insulative protection layer 34 in an applying step (S3) of the present embodiment. In the boundary portion B shown in FIG. 4, the positive electrode mixture layer 32 is arranged overlapping the insulative protection layer 34. The positive electrode mixture layer 32 will now be described with reference to FIG. 4. The positive electrode mixture layer 32 is formed by applying a positive electrode mixture paste 32a to the positive electrode current collector 31 and drying the applied positive electrode mixture paste 32a. The positive electrode mixture layer 32 includes additives such as a conductor 32c, a binder 32d, a dispersant, and the like, in addition to positive electrode active material particles 32b.

Positive Electrode Mixture Paste 32a

The positive electrode mixture paste 32a is a paste obtained by adding a solvent 32e to the additives such as the conductor 32c, the binder 32d, the dispersant, and the like in addition to the positive electrode active material particles 32b. In the applying step (S3) illustrated in FIG. 6, the positive electrode mixture paste 32a is applied to the positive electrode current collector 31 so as to form the positive electrode mixture layer 32. Then, in a drying step (S4), the positive electrode mixture paste 32a applied to the positive electrode current collector 31 is dried and adheres to the positive electrode current collector 31. At the stage shown in FIG. 4, the solvent 32e is mixed in the positive electrode mixture paste 32a. However, after the drying step (S4), the volatilized solvent 32e is absent from the positive electrode mixture layer 32.

Composition of Positive Electrode Active Material Particles 32b

The primary particles of the positive electrode active material particles 32b include a lithium transition metal oxide having a layered crystalline structure. The lithium transition metal oxide includes one or more predetermined transition metal elements in addition to Li. Preferably, the transition metal element included in the lithium transition metal oxide is at least one of Ni, Co, and Mn. A preferred example of the lithium transition metal oxide includes every one of Ni, Co, and Mn.

The positive electrode active material particles 32b may include one or more types of elements in addition to the transition metal element (i.e., at least one of Ni, Co, and Mn). The additional element may include any element in group 1 (alkali metal such as sodium), group 2 (alkaline earth metal such as magnesium or calcium), group 4 (transition metal such as titanium or zirconium), group 6 (transition metal such as chromium or tungsten), group 8 (transition metal such as iron), group 13 (metalloid element such as boron or metal such as aluminum), or group 17 (halogen such as fluorine) of the periodic table.

In a preferred embodiment, the positive electrode active material particles 32b may have a composition (average composition) represented by the following general expression (1).

Li₁+xNiyCozMn(1-y-z)MAαMBβO₂ (1)

In expression 1, the “x” may be a real number that satisfies 0≤x≤0.2. The “y” may be a real number that satisfies 0.1<y<0.6. The “z” may be a real number that satisfies 0.1<z<0.6. The “MA” is at least one type of metal element selected from W, Cr, and Mo. The “α” is a real number that satisfies 0<α≤0.01 (typically, 0.0005≤α≤0.01, for example, 0.001≤α≤0.01). The “MB” may be one or more types of elements selected from the group consisting of Zr, Mg, Ca, Na, Fe, Zn, Si, Sn, Al, B, and F. The “β” may be a real number that satisfies 0≤β≤0.01. The “β” may be substantially zero (that is, oxide including substantially no MB). To facilitate understanding, the chemical formula that expresses the lithium transition metal oxide having a layered structure indicates two as the composition ratio of O (oxygen). However, this numerical value should not be strictly interpreted, and some variations of the composition (typically included in range between 1.95 and 2.05, inclusive) are allowable.

Conductor 32c

The conductor 32c is a material that forms a conductive path in the positive electrode mixture layer 32. When an appropriate amount of the conductor is mixed into the positive electrode mixture layer 32, the conductivity of the positive electrode is increased. This enhances the charging/discharging efficiency and the output characteristics of the battery. The conductor 32c of the present embodiment may include, for example, a carbon material such as carbon nanotubes (CNT) or carbon nanofibers (CNF). Further, the conductor 32c of the present embodiment has the form of a string having the aspect ratio of thirty or greater.

Binder 32d

The binder 32d may include, for example, polyvinylidene fluoride (PVdF), polytetrafluoroethylene (PTFE), polyacrylic acid, polyacrylate, or the like.

Structure of Insulative Protection Layer 34

As shown in FIG. 2, in the positive electrode plate 3, the positive electrode mixture layer 32 is formed on the positive electrode current collector 31, and the insulative protection layer 34 is formed on the positive electrode current collector 31 at a position adjacent to the positive electrode mixture layer 32 and opposing the end of the negative electrode mixture layer 22. In the insulative protection layer 34, the insulative particles 34b are fixed in a state dispersed by the binder 32d. The insulative protection layer 34 is formed by applying an insulative protection paste 34a to a surface of the positive electrode current collector 31 along the ends of the positive electrode mixture layer 32 and drying the paste.

Insulative Protection Paste 34a

The insulative protection paste 34a is a paste obtained by dispersing the insulative particles 34b in a liquid in which the solvent 34d is added to the binder 34c. Further, a dispersant is added to the insulative protection paste 34a so that the insulative particles 34b are uniformly dispersed in the paste.

The insulative protection layer 34 is formed by applying the insulative protection paste 34a to the positive electrode current collector 31 in the applying step (S3) illustrated in FIG. 6. Then, the insulative protection paste 34a is dried and adheres to the positive electrode current collector 31 in the drying step (S4). At the stage shown in FIG. 4, the solvent 34d is mixed in the insulative protection paste 34a. However, after the drying step (S4), the volatilized solvent 34d is absent from the insulative protection layer 34.

Insulative Particles 34b

The insulative particles 34b are disposed between the negative electrode mixture layer 22 and the positive electrode current collector 31 to obtain electrical insulation thereof. The insulative particles 34b are, for example, a ceramic that is obtained by firing a metallic oxide or the like having a high insulation property and a hardness that prevents entry of foreign matter. Specifically, the insulative particles 34b include particles of boehmite, alumina, or the like. In the present embodiment, the insulative particles 34b include boehmite.

Boehmite

Boehmite is an aluminum hydroxide (γ-AlO(OH)) mineral and is a component of aluminum ore bauxite. Boehmite has a glassy to pearly luster, a Mohs hardness of 3 to 3.5, and a specific gravity of 3.00 to 3.07. Boehmite is high in insulation property, heat resistance, and hardness. Thus, boehmite may be industrially used as an inexpensive flame-retardant additive for fire-resistant polymers.

Boehmite is represented by a chemical composition of AlO(OH) or Al₂O₃*H₂O, and is a chemically stable alumina monohydrate that is typically produced by performing a heating treatment or a hydrothermal treatment on alumina trihydrate in air. Boehmite has a high dehydration temperature of 450 to 530° C., and its shape can be controlled into various forms, such as plate-like, needle-like, and hexagonal plate-like, by adjusting the production conditions. Further, the aspect ratio and the particle diameter of boehmite can be controlled by adjusting the production conditions.

Although there are various types of conventional methods for producing boehmite, boehmite is typically produced through hydrothermal treatment of aluminum hydroxide, which is the raw material derived from bauxite. This production method includes a step of stirring and mixing slurry in which water is added to aluminum hydroxide and a reaction accelerator (metal compound). Further, the production method includes a hydrothermal treatment step by which the slurry is wet-cured while being heated in a water vapor atmosphere in a pressure vessel. Furthermore, in the production method, the reaction product undergoes steps of dehydration, water washing, filtration, and drying.

Particle Size of Insulative Particles 34b

When the average particle size (μm (D50)) of the insulative particles 34b is too large, the dispersibility becomes poor. If the average particle size is too small, aggregations form. In the present embodiment, the average particle size of the insulative particles 34b (μm (D50)) is particularly set to 1 to 3 μm to avoid aggregation.

Binder 34c

The binder 34c may include, for example, polyvinylidene fluoride (PVdF), polytetrafluoroethylene (PTFE), polyacrylic acid, polyacrylate, or the like.

Separator 4

The separator 4 may include a porous sheet formed from resin, such as polyethylene (PE), polypropylene (PP), or the like, so as to hold the nonaqueous electrolyte 13 between the positive electrode plate 3 and the negative electrode plate 2. Such a porous resin sheet may have a single-layer structure in which only one type of material is used. Alternatively, the porous resin sheet may have a multilayer structure in which various types of materials are combined.

Method for Manufacturing Positive Electrode Plate 3

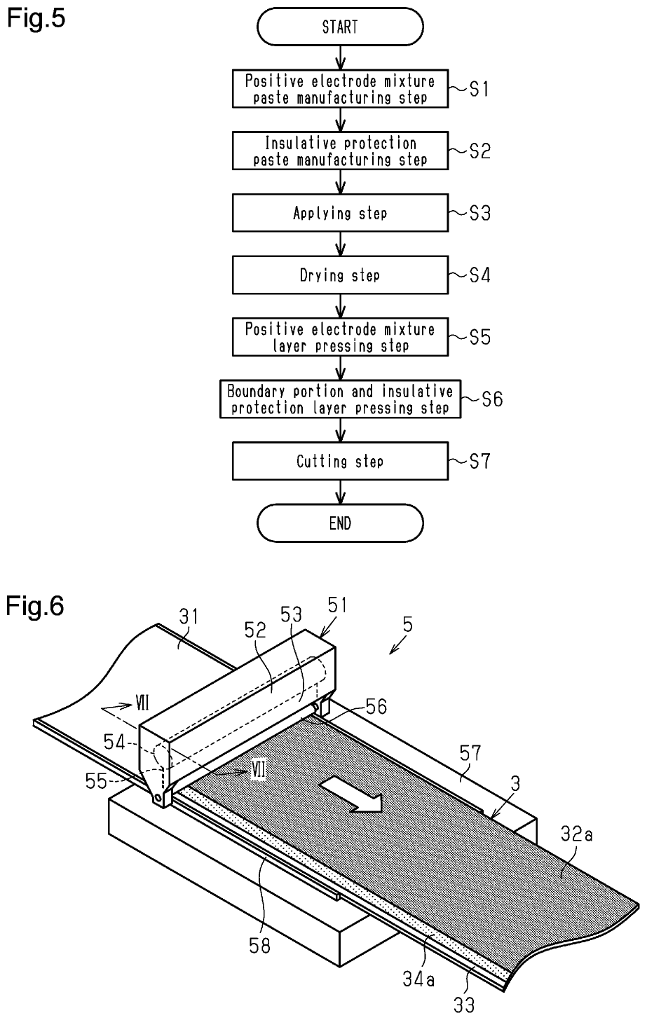

FIG. 5 is a flowchart illustrating a method for manufacturing the positive electrode plate 3 of the present embodiment. The method for manufacturing the positive electrode plate 3 of the present embodiment will now be described with reference to FIG. 5.

Positive Electrode Mixture Paste Manufacturing Step (S1)

First, the positive electrode mixture paste 32a is manufactured. The details of this step are as described above.

Insulative Protection Paste Manufacturing Step (S2)

Further, the insulative protection paste 34a is manufactured. The details of this step are also as described above.

Applying Step (S3)

The applying step (S3) will now be described. The applying step (S3) is a step of simultaneously applying the positive electrode mixture paste 32a prepared in the positive electrode mixture paste manufacturing step (S1) and the insulative protection paste 34a prepared in the insulative protection paste manufacturing step (S2) to a predetermined position of the positive electrode current collector 31.

Structure of Coater 5

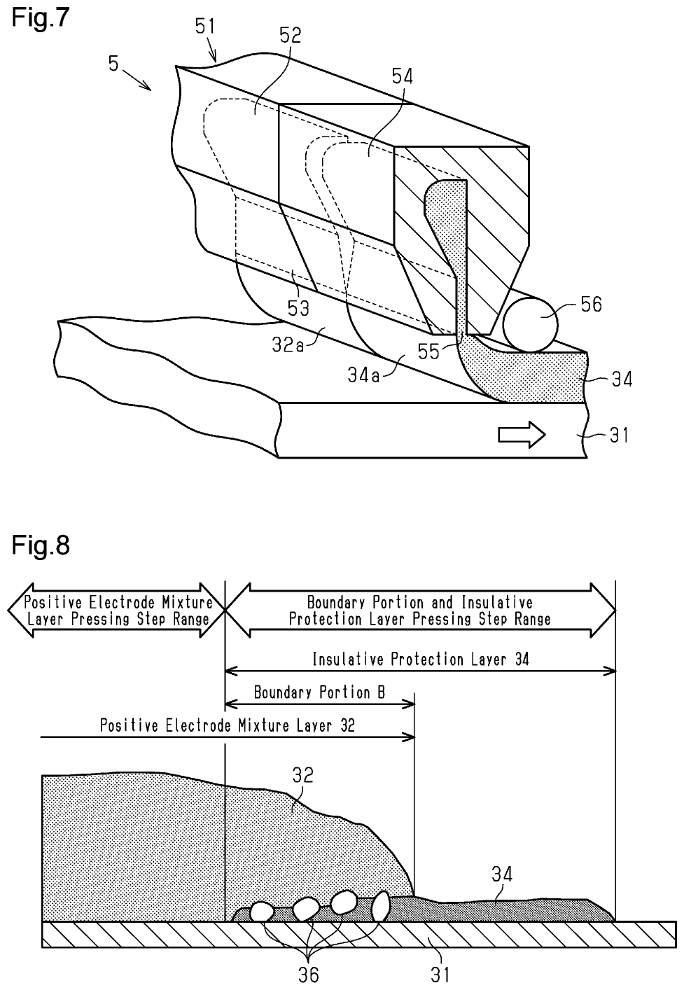

FIG. 6 is a perspective view illustrating the applying step. FIG. 7 is a perspective view schematically showing a first nozzle 53 and a second nozzle 55 of a coater 5 including the cross section of the coater 5 taken along the VII-VII portion. The coater 5 will now be described with reference to FIGS. 6 and 7.

As shown in FIG. 6, the coater 5 includes a stage 57 that acts as a base. The stage 57 includes a positioning guide 58 for conveying an uncut positive electrode current collector 31, which is a long strip of an Al foil. The positive electrode current collector 31 is drawn from a supplying reel (not shown) and conveyed on the stage 57 by a conveying means. A gate-shaped die nozzle 51 is arranged on an end of the stage 57 at the upstream side of the positive electrode current collector 31 in the conveying direction. The die nozzle 51 extends across the positive electrode current collector 31 in a direction orthogonal to the conveying direction. The die nozzle 51 includes a first die 52 that stores the positive electrode mixture paste 32a. The first die 52 is a compartment arranged at a position corresponding to where the positive electrode mixture layer 32 is formed. The first die 52 stores the positive electrode mixture paste 32a supplied from a supplying means (not shown). Further, the die nozzle 51 includes a second die 54. The second die 54 is a compartment arranged at a position corresponding to where the insulative protection layer 34 is formed. The second die 54 stores the insulative protection paste 34a supplied from a supplying means (not shown). The first die 52 and the second die 54 are aligned along a straight line.

The first nozzle 53 is a nozzle that extends from a lower part of the first die 52 to where the positive electrode mixture layer 32 of the positive electrode current collector 31 is formed on the stage 57. When the internal pressure of the first die 52 is increased by a pressurizing means (not shown), a predetermined amount of the positive electrode mixture paste 32a is discharged from the first nozzle 53 to where the positive electrode mixture layer 32 of the positive electrode current collector 31 is formed.

The second nozzle 55 is a nozzle that extends from a lower part of the second die 54 to where the insulative protection layer 34 of the positive electrode current collector 31 is formed on the stage 57. When the internal pressure of the second die 54 is increased by a pressurizing means (not shown), a predetermined amount of the insulative protection paste 34a is discharged from the second nozzle 55 to where the insulative protection layer 34 of the positive electrode current collector 31 is formed.

As shown in FIG. 7, the first nozzle 53 and the second nozzle 55 are separated from each other. The positive electrode mixture paste 32a discharged from the first nozzle 53 and the insulative protection paste 34a discharged from the second nozzle 55 come into contact with each other immediately after the discharge. In the liquid contact state, the positive electrode mixture paste 32a is applied to where the positive electrode mixture layer 32 of the positive electrode current collector 31 is formed. Further, in the liquid contact state, the insulative protection paste 34a is applied to where the insulative protection layer 34 of the positive electrode current collector 31 is formed. Subsequently, a roller 56 shapes the surface of the positive electrode mixture layer 32 and the insulative protection layer 34, which are formed in the applying step. Since the insulative protection layer 34 is thinner than the positive electrode mixture layer 32, only the positive electrode mixture layer 32 is shaped.

Electrode Body 12 after Applying Step (S3)

FIG. 8 shows a state of the electrode body 12 after the applying step (S3) is completed. As shown in FIG. 8, the insulative protection layer 34 is formed on a part of the positive electrode current collector 31. The positive electrode mixture layer 32 is formed adjacent to the insulative protection layer 34. In this case, the positive electrode mixture layer 32 is formed to overlap the end of the insulative protection layer 34. The part where the positive electrode mixture layer 32 overlaps the insulative protection layer 34 is referred to as the boundary portion B. The thickness of the positive electrode mixture layer 32 is referred to as thickness T_{P}. The thickness of the insulative protection layer 34 is referred to as thickness T_{I}. Thickness T_{P} and thickness T_{I} change throughout the manufacturing process. The thickness of the positive electrode mixture layer 32 at the present stage will be referred to as thickness T_{P1}.

As shown in FIG. 7, the first nozzle 53 and the second nozzle 55 are separated from each other and located at the same position in the conveying direction. As described above, in the applying step (S3), the positive electrode mixture paste 32a from the first nozzle 53 and the insulative protection paste 34a from the second nozzle 55 are simultaneously applied to the predetermined position of the positive electrode current collector 31. The boundary portion B as shown in FIG. 8 is formed after the applying step (S3) by adjusting, for example, conditions such as the viscosity of the positive electrode mixture paste 32a and/or the insulative protection paste 34a, the discharge amount, the discharge pressure, and the discharge speed of the first nozzle 53 and/or the second nozzle 55, and the like. The phrase “simultaneously applied” in the applying step (S3) does not have to mean strictly “simultaneous” as long as the problem that the present disclosure is to solve is solved, for example, as long as the boundary portion B as shown in FIG. 8 is formed after the applying step (S3). For example, the first nozzle 53 and the second nozzle 55 may be shifted from each other in the conveying direction. Further, the first nozzle 53 may be arranged at the downstream of the second nozzle 55 in the conveying direction.

In the boundary portion B, air bubbles are likely to form at the boundary of the positive electrode mixture layer 32 and the insulative protection layer 34. It is desirable that the bubbles be removed because such bubbles may cause delamination.

Drying Step (S4)

As described above, the drying step (S3) is performed in a state in which the positive electrode mixture paste 32a and the insulative protection paste 34a are mixed in a mixed layer after the applying step (S4). In the drying step (S4), the solvent 32e of the positive electrode mixture layer 32 is volatilized so that the paste of the positive electrode mixture layer 32 becomes a solid that is not mixed with the insulative protection layer 34. Further, the solvent 34d of the insulative protection layer 34 is also volatilized so that the paste of the insulative protection layer 34 becomes a solid that is not mixed with the positive electrode mixture layer 32. The layers are stabilized in such state.

Positive Electrode Mixture Layer Pressing Step (S5)

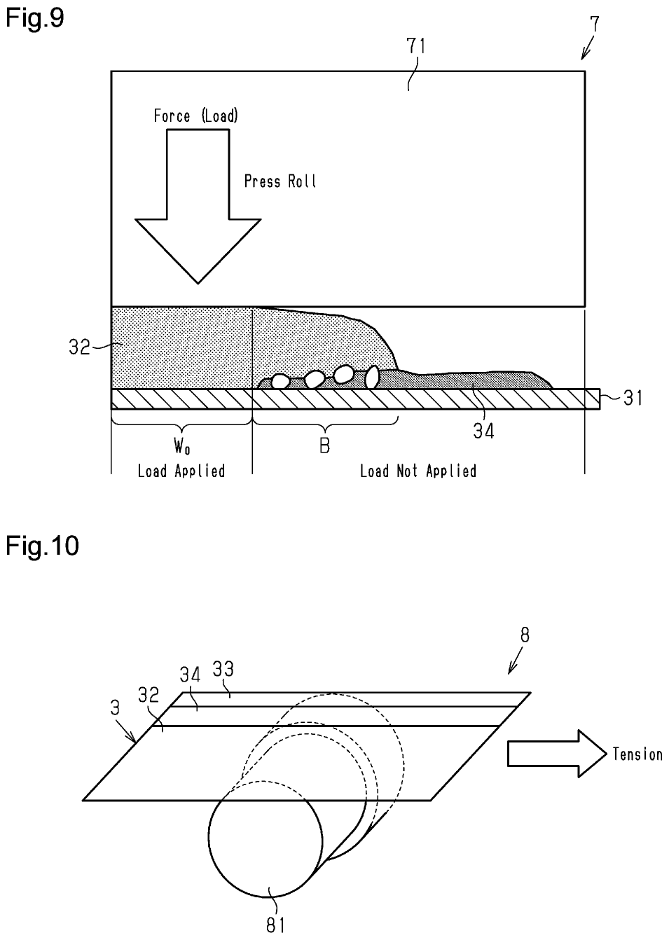

FIG. 9 is a diagram schematically illustrating the positive electrode mixture layer pressing step (S5). After the drying step (S4), the positive electrode mixture layer 32 and the insulative protection layer 34 shown in FIG. 8 already have a certain hardness. In the positive electrode mixture layer pressing step (S5), a pressing machine (not shown) shapes the positive electrode mixture layer 32 shown in FIG. 8 into a plane having a predetermined thickness. Even after the drying step (S4), thickness T_{I} of the insulative protection layer 34 is less than thickness T_{P} of the positive electrode mixture layer 32. As shown in FIG. 9, a press roll 71 of the pressing machine 7 used in the positive electrode mixture layer pressing step (S5) presses the entire positive electrode plate 3 that underwent the drying step (S4). In this case, since thickness T_{I} of the insulative protection layer 34 is less than thickness T_{P1} of the positive electrode mixture layer 32 as shown in FIG. 8, the press roll 71 exerts a force on the entire positive electrode mixture layer 32. The gap between the press roll 71 and the positive electrode current collector 31 is set to be less than thickness T_{P1} of the positive electrode mixture layer 32 and greater than thickness T_{P2} of the insulative protection layer 34. Thus, only the positive electrode mixture layer 32 is pressed in the positive electrode mixture layer pressing step (S5). As a result, the positive electrode mixture layer 32 is shaped into a plane having the uniform thickness of T_{I2}. In this case, part of the insulative protection layer 34 included in the boundary portion B is pressed together with the positive electrode mixture layer 32.

The load of the press roll 71 is only applied to the insulative protection layer 34 included in the boundary portion B.

Boundary Portion and Insulative Protection Layer Pressing Step (S6)

FIG. 10 is a perspective view schematically illustrating a boundary portion and insulative protection layer pressing step (S6). In the boundary portion and insulative protection layer pressing step (S6), a certain tension is applied to the long positive electrode plate, which is drawn from a reel (not shown), so that the positive electrode is forced against a stepped roll 81 of a pressing machine 8, used to press the boundary portion and the insulative protection layer.

FIG. 11 is a cross-sectional view schematically illustrating when the boundary portion and insulative protection layer pressing step (S6) is initiated. As shown in FIG. 11, the stepped roll 81 includes a cylindrical first surface 81a having the largest radius, a cylindrical third surface 81c having the smallest radius, and a truncated conical second surface 81b that connects the first surface 81a and the third surface 81c. The first surface 81a opposes mainly the insulative protection layer 34. The second surface 81b opposes mainly the boundary portion B. The third surface 81c opposes mainly the positive electrode mixture layer 32 except for the boundary portion B. The third surface 81c is spaced apart from the positive electrode mixture layer 32 such that the third surface 81c does not contact the positive electrode mixture layer 32. Specifically, a surface orthogonal to the rotation axis of the stepped roll 81 is arranged between the second surface 81b and the third surface 81c so as to form a large gap that avoids the contact between the third surface 81c and the positive electrode mixture layer 32.

Thus, when tension is applied to the positive electrode current collector 31 of the long positive electrode plate 3 with respect to the stepped roll 81, the tensioned positive electrode current collector 31 and the stepped roll 81 sandwich and press the boundary portion B of the positive electrode plate 3 and the insulative protection layer 34.

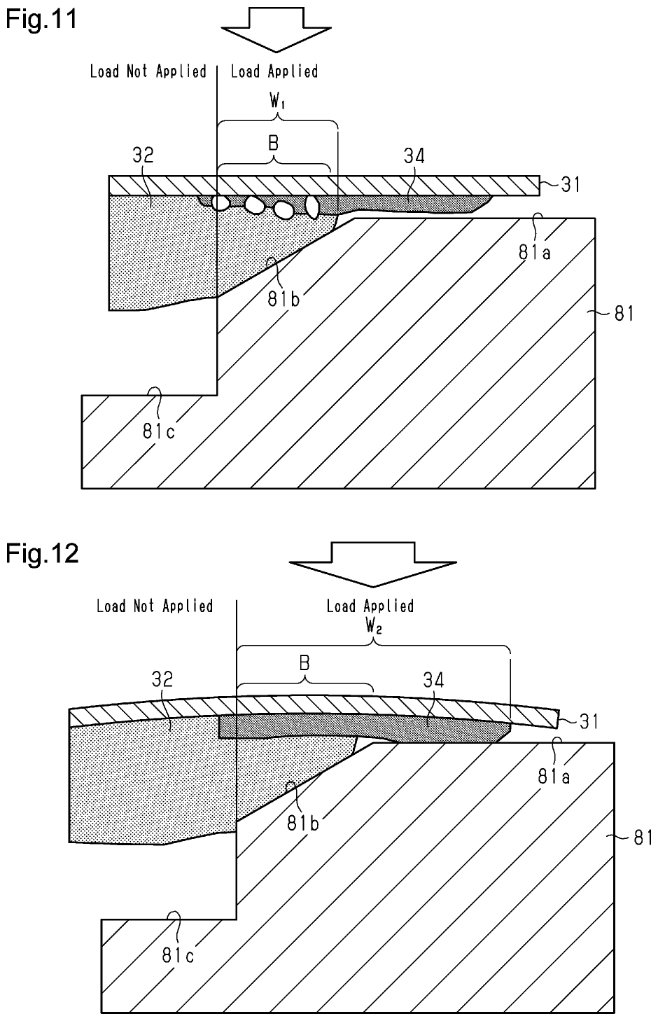

FIG. 12 is a diagram schematically showing the operation of the boundary portion and insulative protection layer pressing step (S6). As shown in FIG. 12, when tension is applied to the positive electrode current collector 31, the positive electrode current collector 31 forces the positive electrode plate 3 against the stepped roll 81. In this case, the first surface 81a forces the insulative protection layer 34 against the positive electrode current collector 31. Simultaneously, the second surface 81b forces the boundary portion B against the positive electrode current collector 31. In this manner, the first surface 81a compresses the insulative protection layer 34 and adjusts thickness T_{I} (μm) of the insulative protection layer 34 to a predetermined thickness. This decreases porosity P_{I} (%) of the insulative protection layer 34 and increases density D_{I} (g/cm³) of the insulative protection layer 34. In addition, the second surface 81b compresses the boundary portion B to adjust thicknesses T_{P} (μm) of the positive electrode mixture layer 32 and thickness T_{I} (μm) of the insulative protection layer 34 to predetermined thicknesses. This decreases porosity P_{P} (%) of the positive electrode mixture layer 32 and increases density D_{P} (g/cm³) of the positive electrode mixture layer 32. Also, this decreases porosity P_{I} (%) of the insulative protection layer 34 and increases density D_{I} (g/cm³) of the insulative protection layer 34. Furthermore, the bubbles 36 formed at the boundary of the positive electrode mixture layer 32 and the insulative protection layer 34 in the boundary portion B (refer to FIG. 8) are eliminated.

In the boundary portion and insulative protection layer pressing step (S6), tension is applied to the long positive electrode current collector 31, which is drawn from an accommodation reel (not shown), so that the positive electrode plate 3 is forced against the stepped roll 81. As in the positive electrode mixture layer pressing step (S6) shown in FIG. 9, when the hard press roll 71 is forced against the positive electrode plate 3 placed on the hard and flat stage 57, the shape of the press roll 71 is firmly transcribed to the positive electrode plate 3 when the surface of the positive electrode plate 3 is uneven. In the boundary portion and insulative protection layer pressing step (S6), tension is applied to the positive electrode current collector 31 so that the positive electrode plate 3 is forced against the stepped roll 81. In this case, since the positive electrode current collector 31 is a thin metal foil formed from Al or an Al alloy, the positive electrode current collector 31 is easily bent. Accordingly, the positive electrode current collector 31 is deformed in correspondence with the shapes of the positive electrode mixture layer 32 and the insulative protection layer 34 on the surface of the positive electrode plate 3 so that the entire positive electrode mixture layer 32 and the entire insulative protection layer 34 are uniformly forced against the stepped roll 81.

In the boundary portion and insulative protection layer pressing step (S6), thickness T_{I} (μm), porosity P_{I} (%), and density D_{I} (g/cm³) of the insulative protection layer 34 are adjustable by changing the pressing strength. Thickness T_{P} (μm), porosity P_{P} (%), and density D_{P} (g/cm³) of the positive electrode mixture layer 32 are also adjustable by changing the pressing strength.

Cutting Step (S7)

When the thickness, porosity, and density are adjusted to desired values in the boundary portion and insulative protection layer pressing step (S6), the manufacture of the positive electrode mixture layer 32 and the insulative protection layer 34 is completed. Then, in a cutting step (S7), the positive electrode current collector 31 is cut to a length that corresponds to the electrode body 12. This completes the manufacture of the positive electrode plate 3.

Method for Manufacturing Vehicle Battery Pack

When the positive electrode plate 3 is obtained by the above manufacturing method of the positive electrode plate 3, the negative electrode plate 2 and the positive electrode plate 3 are stacked with the separator 4 held in between and rolled to form the electrode body 12. Subsequently, the positive electrode external terminal 14 and the negative electrode external terminal 15 are attached to the electrode body 12 via a lid of the battery case 11. Then, the electrode body 12 is accommodated in the battery case 11, and the lid is airtightly joined with the battery case 11 by laser welding or the like. After the battery case 11 accommodating the electrode body 12 is dried, the nonaqueous electrolyte 13 is injected into the battery case 11 and then the battery case 11 is sealed. Afterwards, the battery cell undergoes conditioning such as initial charging, open circuit voltage (OCV) testing, internal resistance testing, and aging. Multiple battery cells are stacked to form an assembled battery. Further, multiple assembled batteries are accommodated in a battery pack. A vehicle on-board lithium-ion rechargeable battery is completed when a controller and the like are mounted on the battery pack for monitoring and controlling charging, discharging, and the like of the battery pack.

Operation of Present Embodiment

### EXPERIMENTAL EXAMPLES

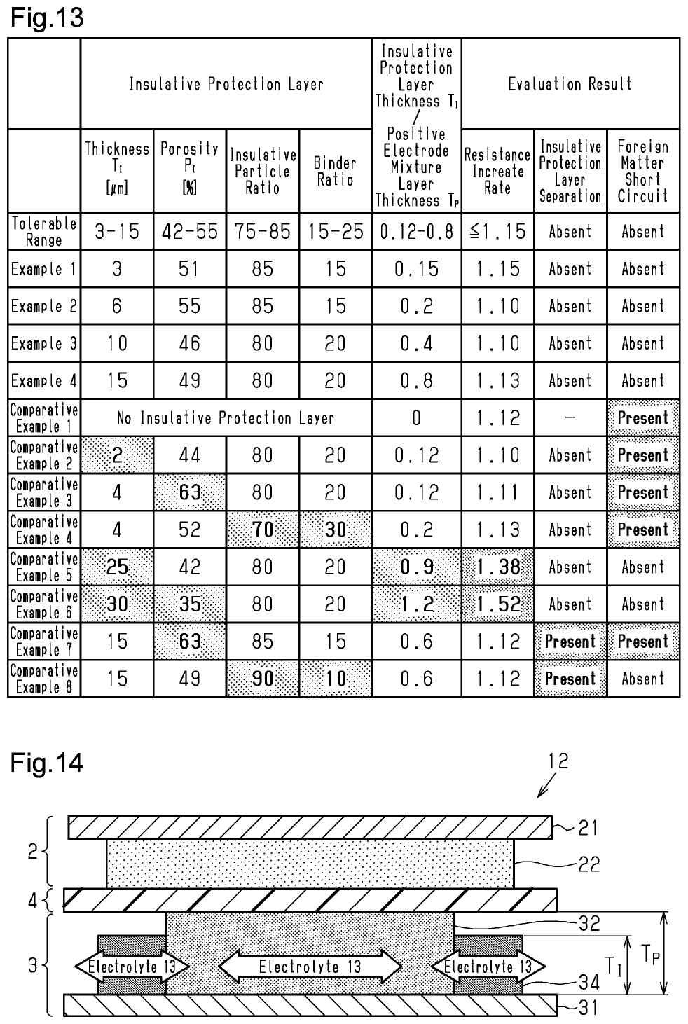

FIG. 13 is a table showing the results of experimental examples. The lithium-ion rechargeable battery 1 of the present embodiment has the above-described structure. Examples 1 to 4 that have the structure of the present embodiment and Comparative Examples 1 to 6 that do not have the above-described structure were tested and compared.

Conditions of Lithium-Ion Rechargeable Battery 1 of Present Embodiment

The conditions of the lithium-ion rechargeable battery 1 in accordance with the present embodiment are now described as the “tolerable range”.

Thickness T_{I} (μm) of the insulative protection layer 34 is 3 to 15 μm.

Porosity P_{I} (%) of the insulative protection layer 34 is between 42% and 55%, inclusive.

In the composition of the insulative protection layer 34, the value of (insulative particles 34b)/(insulative particles 34b+binder 34c) on a weight basis is between 75 wt % and 85 wt %, inclusive. With respect to the binder 34c, the value of (binder 34c)/(insulative particles 34b+binder 34c) is between 15 wt % and 25 wt %, inclusive.

A ratio of single-surface thickness T_{I} (μm) of insulative protection layer 34 to single-surface thickness T_{P} (μm) of the positive electrode mixture layer 32 is between 0.12 and 0.80, inclusive.

The resistance increase rate (internal resistance DC-IR) is 1.15 or less.

Separation of the insulative protection layer 34 from the positive electrode current collector 31 is “absent”.

Short circuiting caused by foreign matter is “absent”.

### Example 1

In Example 1, thickness T_{I} (μm) of the insulative protection layer 34 was 3 porosity P_{I} (%) was 51%, the ratio of the insulative particles 34b was 85 wt %, the ratio of the binder 34c was 15 wt %, and the value of thickness T_{I}/thickness T_{P} was 0.15.

The evaluation results showed that the resistance increase rate was 1.15, which is in the tolerable range, separation of the insulative protection layer was “absent”, and short circuiting caused by foreign matter was “absent”.

### Example 2

In Example 2, thickness T_{I} (μm) of the insulative protection layer 34 was 6 μm, porosity P_{I} (%) was 55%, ratio of the insulative particles 34b was 85 wt %, the ratio of the binder 34c was 15 wt %, and the value of thickness T_{I}/thickness T_{P} was 0.2.

The evaluation results showed that the resistance increase rate was 1.10, which is in the tolerable range, separation of the insulative protection layer was “absent”, and short circuiting caused by foreign matter was “absent”.

### Example 3

In Example 3, thickness T_{I} (μm) of the insulative protection layer 34 was 10 μm, porosity P_{I} (%) was 46%, the ratio of the insulative particles 34b was 80 wt %, the ratio of the binder 34c was 20 wt %, and the value of thickness T_{I}/thickness T_{P} was 0.4.

The evaluation results showed that the resistance increase rate was 1.10, which is in the tolerable range, separation of the insulative protection layer was “absent”, and short circuiting caused by foreign matter was “absent”.

### Example 4

In Example 4, thickness T_{I} (μm) of the insulative protection layer 34 was 15 porosity P_{I} (%) was 49%, the ratio of the insulative particles 34b was 80 wt %, the ratio of the binder 34c was 20 wt %, and the value of thickness T_{I}/thickness T_{P} was 0.8.

The evaluation results showed that the resistance increase rate was 1.13, which is in the tolerable range, separation of the insulative protection layer was “absent”, and short circuiting caused by foreign matter was “absent”.

### Comparative Example 1

Comparative Example 1 is a comparative example that does not include the insulative protection layer 34.

The evaluation results showed that the resistance increase rate was 1.12, and short circuiting caused by foreign matter was “present”. That is, there was a problem of occurrence of short circuiting caused by foreign matter.

### Comparative Example 2

In Comparative Example 2, thickness T_{I} (μm) of the insulative protection layer 34 was 2 μm, porosity P_{I} (%) was 44%, the ratio of the insulative particles 34b was 80 wt %, the ratio of the binder 34c was 20 wt %, and the value of thickness T_{I}/thickness T_{P} was 0.12.

In this example, thickness T_{I} (μm) of the insulative protection layer 34 was 2 μm, which is less than the tolerable value of 3.

The evaluation results showed that the resistance increase rate was 1.10, separation of the insulative protection layer was “absent”, and short circuiting caused by foreign matter was “present”. That is, there was a problem of occurrence of short circuiting caused by foreign matter.

### Comparative Example 3

In Comparative Example 3, thickness T_{I} (μm) of the insulative protection layer 34 was 4 μm, porosity P_{I} (%) was 63%, the ratio of the insulative particles 34b was 80 wt %, the ratio of the binder 34c was 20 wt %, and the value of thickness T_{I}/thickness T_{P} was 0.12.

In this example, porosity P_{I} (%) was 63%, which is greater than the tolerable value of 55%.

The evaluation results showed that the resistance increase rate was 1.11, separation of the insulative protection layer was “absent”, and short circuiting caused by foreign matter was “present”. That is, there was a problem of occurrence of short circuiting caused by foreign matter.

### Comparative Example 4

In Comparative Example 4, thickness T_{I} (μm) of the insulative protection layer 34 was 4 μm, porosity P_{I} (%) was 52%, the ratio of the insulative particles 34b was 70 wt %, the ratio of the binder 34c was 30 wt %, and the value of thickness T_{I}/thickness T_{P} was 0.2.

In this example, the ratios of the insulative particles 34b and the binder 34c were 70 wt % and 30 wt %, respectively. The ratio of the insulative particles 34b is less than the tolerable value of 75 wt % or greater, and the ratio of the binder 34c is greater than the tolerable value of 25 wt % or less.

The evaluation results showed that the resistance increase rate was 1.13, separation of the insulative protection layer was “absent”, and short circuiting caused by foreign matter was “present”. That is, there was a problem of occurrence of short circuiting caused by foreign matter.

### Comparative Example 5

In Comparative Example 5, thickness T_{I} (μm) of the insulative protection layer 34 was 25 μm, porosity P_{I} (%) was 42%, the ratio of the insulative particles 34b was 80 wt %, the ratio of the binder 34c was 20 wt %, and the value of thickness T_{I}/thickness T_{P} was 0.9.

In this example, thickness T_{I} (μm) of the insulative protection layer 34 was 25 μm, which is greater than the tolerable value of 15 μm. Further, the value of thickness T_{I}/thickness T_{P} was 0.9, which is greater than the tolerable value of 0.8.

The evaluation results showed that the resistance increase rate was 1.38, separation of the insulative protection layer was “absent”, and short circuiting caused by foreign matter was “absent”. That is, there was a problem in that the resistance increase rate was 1.38, which is greater than the tolerable value of 1.15.

### Comparative Example 6

In Comparative Example 6, thickness T_{I} (μm) of the insulative protection layer 34 was 30 μm, porosity P_{I} (%) was 35%, the ratio of the insulative particles 34b was 80 wt %, the ratio of the binder 34c was 20 wt %, and the value of thickness T_{I}/thickness T_{P} was 1.2.

In this example, thickness T_{I} (μm) of the insulative protection layer 34 was 301 μm, which is greater than the tolerable value of 15 μm. Further, the value of thickness T_{I}/thickness T_{P} was 1.2, which is greater than the tolerable value of 0.8.

The evaluation results showed that the resistance increase rate was 1.52, separation of the insulative protection layer was “absent”, and short circuiting caused by foreign matter was “absent”. That is, there was a problem in that the resistance increase rate was 1.52, which is greater than the tolerable value of 1.15.

### Comparative Example 7

In Comparative Example 7, thickness T_{I} (μm) of the insulative protection layer 34 was 15 μm, porosity P_{I} (%) was 63%, the ratio of the insulative particles 34b was 85 wt %, the ratio of the binder 34c was 15 wt %, and the value of thickness T_{I}/thickness T_{P} was 0.6.

In this example, porosity P_{I} (%) was 63%, which is greater than the tolerable value of 55%.

The evaluation results showed that the resistance increase rate was 1.12, separation of the insulative protection layer was “present”, and short circuiting caused by foreign matter was “present”. In other words, there were problems of separation of the insulative protection layer and occurrence of short circuiting caused by foreign material.

### Comparative Example 8

In Comparative Example 8, thickness T_{I} (μm) of the insulative protection layer 34 was 15 μm, porosity P_{I} (%) was 49%, the ratio of the insulative particles 34b was 90 wt %, the ratio of the binder 34c was 10 wt %, and the value of thickness T_{I}/thickness T_{P} was 0.6.

In this example, the ratios of the insulative particles 34b and the binder 34c were 90 wt % and 10 wt %, respectively. The ratio of the insulative particles 34b is greater than the tolerable value of 85 wt %, and the ratio of the binder 34c is less than the tolerable value of 15 wt %.

The evaluation results showed that the resistance increase rate was 1.12, separation of the insulative protection layer was “present”, and short circuiting caused by foreign matter was “absent”. In other words, there was a problem of separation of the insulative protection layer.

Experimental Examples Summary

Comparative Examples 1 to 4 and 7 indicated that the insulative protection layer 34 has an effect of avoiding short circuiting caused by foreign matter. In particular, it was found that such an insulative protection layer 34 has the conditions in which thickness T_{I} (μm) is 3 μm or greater, porosity P_{I} (%) is 55% or less, the ratio of the insulative particles 34b is 75 wt % or greater, and the ratio of the binder 34c is 25 wt % or less.

Based on Comparative Examples 5 and 6, it was found that the conditions for limiting the resistance increase rate to 1.15 times or less include that the ratio of thickness T_{I} (μm) of the insulative protection layer 34 to thickness T_{P} (μm) of the positive electrode mixture layer 32 is 0.8 or less.

Based on Comparative Examples 7 and 8, it was found that the conditions for avoiding separation of the insulative protection layer 34 include that porosity P_{I} (%) of the insulative protection layer 34 is 55% or less, the ratio of the insulative particles 34b is 85 wt % or less, and the ratio of the binder 34c is 15 wt % or greater.

Advantages of Present Embodiment
(1) The lithium-ion rechargeable battery 1 and the method for manufacturing the positive electrode plate 3 of the present embodiment avoid high-rate deterioration caused by the insulative protection layer 34, and avoid delamination of the insulative protection layer 34 from the positive electrode current collector 31.
(2) In the composition of the insulative protection layer 34, the value of (insulative particles 34b)/(insulative particles 34b+binder 34c) on a weight basis is 75 wt % or greater. This maintains the insulation property of the insulative protection layer 34 against foreign matter effectively.

Further, the value of (insulative particles 34b)/(insulative particles 34b+binder 34c) is set to 85 wt % or less. This avoids delamination of the insulative protection layer 34 from the positive electrode current collector 31 effectively.
(3) Single-surface thickness T_{I} of the insulative protection layer 34 is 3.0 μm or greater. This maintains the insulation property of the insulative protection layer 34 against foreign matter effectively.

Single-surface thickness T_{I} of the insulative protection layer 34 is set to 15 μm or less. This facilitates the movement of the electrolyte.
(4) When porosity P_{I} of the insulative protection layer 34 is 42% or greater, the electrolyte moves easily. Further, when porosity P_{I} of the insulative protection layer 34 is 55% or less, the insulative protection layer 34 has an increased mechanical strength and an improved insulation property while avoiding the delamination of the insulative protection layer 34 effectively.
(5) When the ratio of single-surface thickness T_{I} of the insulative protection layer 34) to single-surface thickness T_{P} of the positive electrode mixture layer 32 is 0.12 or greater, a sufficient thickness T_{I} of the insulative protection layer 34 is ensured effectively. Further, when the ratio of single-surface thickness T_{I} of the insulative protection layer 34 to single-surface thickness T_{P} of the positive electrode mixture layer 32 is 0.80 or less, further preferably 0.60 or less, the electrolyte moves easily.
(6) When density D_{P} of the positive electrode mixture layer is set to 2.2 g/cm³ or greater, the battery capacity is improved effectively. Further, when the concentration is 3.0 g/cm³ or less, the electrolyte moves easily.
(7) When porosity P_{P} of the positive electrode mixture layer is 30% or greater, the electrolyte moves easily. Further, when porosity P_{P} of the positive electrode mixture layer is 50% or less, the battery capacity is improved effectively.
(8) When the conductor 32c of the positive electrode mixture layer 32 is formed by a conductive material having the aspect ratio of thirty or greater, a small mass of the conductor 32c can form the conductive network effectively.
(9) When the conductor 32c is carbon nanotubes or carbon nanofibers, the conductor 32c has a high aspect ratio.
(10) When density D_{I} of the insulative protection layer 34 is greater than or equal to 1.2 g/cm³, the mechanical strength of the insulative protection layer 34 is increased, and the delamination of the insulative protection layer 34 is avoided. Further, when density D_{I} of the insulative protection layer 34 is 1.6 g/cm³ or less, the movement of the electrolyte is will not be hindered.
(11) When the delamination strength is 10 N or greater, delamination of the insulative protection layer 34 from the positive electrode current collector 31 is avoided.
(12) When the positive electrode mixture layer 32 overlaps the insulative protection layer 34 in the boundary portion B where the positive electrode mixture layer 32 is adjacent to the insulative protection layer 34, delamination of the insulative protection layer 34 from the positive electrode current collector 31 is avoided effectively.
(13) When boehmite or alumina is used as the insulative particles 34b, the insulative protection layer 34 has a high insulation property and a high mechanical strength.
(14) In the method for manufacturing the positive electrode plate 3 of the lithium-ion rechargeable battery 1 in accordance with the present embodiment, the insulative protection paste 34a and the positive electrode mixture paste 32a are simultaneously applied to the surface of the positive electrode current collector 31 in the applying step (S3). This forms the boundary portion B where the positive electrode mixture layer 32 overlaps the insulative protection layer 34. Thus, delamination of the insulative protection layer 34 is avoided effectively.
(15) The positive electrode mixture layer 32 is pressed in the positive electrode mixture layer pressing step (S5), and the insulative protection layer 34 and the boundary portion B are simultaneously pressed in the boundary portion and insulative protection layer pressing step (S6). This appropriately forms the positive electrode mixture layer 32, the insulative protection layer 34, and the boundary portion B.
(16) The boundary portion and insulative protection layer pressing step (S6) is roller pressing and uses the stepped roll 81 that is stepped to have different radii in order to press the insulative protection layer 34 and the boundary portion B without pressing the positive electrode mixture layer 32. This appropriately forms the insulative protection layer 34 and the boundary portion B.
(17) In the boundary portion and insulative protection layer pressing step (S6), tension is applied to the positive electrode current collector 31 so that the insulative protection layer 34 and the boundary portion B are forced against the stepped roll 81. Since the positive electrode current collector 31 is flexible, the insulative protection layer 34 and the boundary portion B are appropriately pressed in correspondence with their shapes.

### Modified Examples

The above embodiment is an example of the present disclosure, and can be modified and implemented as follows.

In the present embodiment, the positive electrode mixture layer 32 and the insulative protection layer 34 are formed on both surfaces of the positive electrode current collector 31 so that the present disclosure is implemented on both surfaces. However, the present disclosure may be implemented on the positive electrode current collector 31 on only one surface. Further, the positive electrode mixture layer 32 and the insulative protection layer 34 may be formed on only one surface of the positive electrode current collector 31, and the present disclosure may be implemented on that surface.

In the present embodiment, the lithium-ion rechargeable battery 1 is described as an example of a nonaqueous electrolyte rechargeable battery that is a plate-shaped battery cell to be mounted on a vehicle. However, the nonaqueous electrolyte rechargeable battery is not limited to such a structure and may be cylindrical and/or stationary. Further, the electrode body 12 is not limited to a flat roll type and may be a stack of rectangular plate-shaped electrodes. In addition, there is no limitation to the shape of the positive electrode external terminal 14 and the negative electrode external terminal 15.

The drawings are provided to illustrate the present embodiment, and depiction of elements may be exaggerated for clarity. Thus, the present disclosure is not limited to the drawings.

The flowchart shown in FIG. 5 is an example of the present disclosure. Another step may be added or some of the steps may be deleted. Further, the steps may be performed in any order. For example, the drying step (S4) may be performed after the positive electrode mixture layer pressing step (S5).

The numerical values and ranges are merely examples, and can be optimized by one skilled in the art.

The composition, material characteristics, and the like of the positive electrode mixture paste 32a and the insulative protection paste 34a are examples of the present disclosure, and can be optimized by one skilled in the art.

The present embodiment is an embodiment of the present disclosure. It should be apparent to one skilled in the art that the present disclosure is not limited to the embodiment and can be implemented by adding, deleting, or changing the structure without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A nonaqueous electrolyte rechargeable battery, the battery comprising:
a positive electrode plate;
a negative electrode plate;
a separator insulating the positive electrode plate and the negative electrode plate; and
a nonaqueous electrolyte, wherein:
the positive electrode plate includes a positive electrode current collector, a positive electrode mixture layer arranged on a part of at least one surface of the positive electrode current collector and including positive electrode active material particles and a conductor, and an insulative protection layer arranged on another part of the at least one surface of the positive electrode current collector adjacent to the positive electrode mixture layer and including insulative particles and a binder;
in the insulative protection layer, a value of (the insulative particles)/(the insulative particles+the binder) is between 75 wt % and 85 wt %, inclusive;
a single-surface thickness T_{I} of the insulative protection layer is between 3.0 μm and 15 μm inclusive;
a porosity P_{I} of the insulative protection layer is between 42% and 55%, inclusive; and
a ratio of the single-surface thickness T_{I} of the insulative protection layer to a single-surface thickness T_{P} of the positive electrode mixture layer is between 0.12 and 0.80, inclusive.

2. The battery according to claim 1, wherein:
the ratio of the single-surface thickness T_{I} of the insulative protection layer to the single-surface thickness T_{P} of the positive electrode mixture layer is between 0.12 and 0.60, inclusive;
a density D_{P} of the positive electrode mixture layer is between 2.2 g/cm³ and 3.0 g/cm³, inclusive; and
a porosity P_{P} of the positive electrode mixture layer is between 30% and 50%, inclusive.

3. The battery according to claim 1, wherein the conductor of the positive electrode mixture layer is a conductive material having an aspect ratio of thirty or greater.

4. The battery according to claim 3, wherein the conductor is formed by carbon nanotubes or carbon nanofibers.

5. The battery according to claim 1, wherein the insulative protection layer has a density D_{I} of between 1.2 g/cm³ and 1.6 g/cm³, inclusive and a delamination strength of 10 N or greater.

6. The battery according to claim 1, wherein the positive electrode mixture layer overlaps the insulative protection layer at a boundary portion where the positive electrode mixture layer is adjacent to the insulative protection layer.

7. The battery according to claim 1, wherein the insulative particles are formed from boehmite or alumina.

8. A method for manufacturing a positive electrode plate of a nonaqueous electrolyte rechargeable battery, wherein:
the nonaqueous electrolyte rechargeable battery includes a positive electrode plate, a negative electrode plate, a separator insulating the positive electrode plate and the negative electrode plate, and a nonaqueous electrolyte; and
the positive electrode plate includes a positive electrode current collector, a positive electrode mixture layer arranged on a part of at least one surface of the positive electrode current collector and including positive electrode active material particles and a conductor, and an insulative protection layer arranged on another part of the at least one surface of the positive electrode current collector adjacent to the positive electrode mixture layer and including insulative particles and a binder,
the method comprising:
simultaneously applying an insulative protection paste including insulative particles, a binder, and a solvent, and a positive electrode mixture paste including positive electrode active material particles, a conductor, a binder, and a solvent on a surface of the positive electrode current collector to form the positive electrode mixture layer, the insulative protection layer arranged adjacent to the positive electrode mixture layer, and a boundary portion where the positive electrode mixture layer overlaps the insulative protection layer;
pressing the positive electrode mixture layer; and
simultaneously pressing the insulative protection layer and the boundary portion.

9. The method according to claim 8, wherein at the boundary portion, the insulative protection layer is formed on the positive electrode current collector, and the positive electrode mixture layer is formed overlapping the insulative protection layer.

10. The method according to claim 8, wherein the pressing the insulative protection layer and the boundary portion is roller pressing and uses a stepped roll that is stepped to have different radii in order to press the insulative protection layer and the boundary portion without pressing the positive electrode mixture layer.

11. The method according to claim 10, wherein the pressing the insulative protection layer and the boundary portion includes applying tension to the positive electrode current collector so that the insulative protection layer and the boundary portion are forced against the stepped roll.
